(19) United States
(12) Patent Application Publication
(10) Pub. No.: US 2022/0389607 A1
(43) Pub. Date: Dec. 8, 2022

(54) METHOD FOR REDUCING THE CONCENTRATION OF IRON IONS IN A TRIVALENT CHROMIUM ELETROPLATING BATH

(71) Applicant: Atotech Deutschland GmbH & Co. KG, Berlin (DE)

(72) Inventors: Michael MUIGG, Berlin (DE); Anke WALTER, Berlin (DE); Sebastian KÜHNE, Berlin (DE)

(21) Appl. No.: 17/775,945

(22) PCT Filed: Dec. 17, 2020
(86) PCT No.: PCT/EP2020/086882

§ 371 Date: May 11, 2022

(30) Foreign Application Priority Data
Dec. 18, 2019 (EP) 19217608.9

(51) Int. Cl. C25D 21/22; C25D 3/06; C25D 21/10; B01D 15/36

(52) U.S. Cl. CPC C25D 21/22; C25D 3/06; C25D 21/10; B01D 15/362

(57) ABSTRACT

Method for reducing concentration of iron ions in a trivalent chromium electroplating bath, including:
(i) providing the trivalent chromium electroplating bath including trivalent chromium ions, and iron ions,
(ii) subjecting at least a portion of the bath to air agitation, to obtain an air-agitated portion of the bath,
(iii) contacting the air-agitated portion with an ion exchange resin, to obtain a resin-treated portion of the bath, and
(iv) returning the resin-treated portion of the bath to the trivalent chromium electroplating bath,
   provided that
   the bath provided in step (i) was or is utilized for electrodepositing chromium on a substrate applying a cathodic current density of 18 A/dm² or more,
   after step (iii), iron ions in the resin-treated portion have a lower concentration than in the air-agitated portion, and
   after step (iv), iron ions in the bath have a concentration below 50 mg/L.

### FIELD OF THE INVENTION

The present invention relates to a method for reducing the concentration of iron ions in a trivalent chromium electroplating bath. In particular the trivalent chromium electroplating bath subjected to the method of the present invention allows for the electrolytic deposition of functional chromium layers, also called hard chromium layers, on a substrate, in particular on a ferrous substrate, most particular on a nickel or nickel alloy coated ferrous substrate.

### BACKGROUND OF THE INVENTION

Functional chromium layers usually have a much higher average layer thickness, typically from at least 1 μm up to several hundreds of micro meters, compared to decorative chromium layers, typically significantly below 1 μm (even below 500 nm), and are characterized by excellent hardness and wear resistance.

Functional chromium layers obtained from an electroplating bath containing hexavalent chromium are known in the prior art and are a well-established standard.

During recent decades, chromium deposition methods relying on hexavalent chromium are more and more replaced by deposition methods relying on trivalent chromium. Such trivalent chromium-based methods are much more health- and environment friendly.

WO 2015/110627 A1 refers to an electroplating bath for depositing chromium and to a method for depositing chromium on a substrate using said electroplating bath.

U.S. Pat. No. 2,748,069 relates to an electroplating solution of chromium, which allows obtaining very quickly a chromium coating of very good physical and mechanical properties. The chromium plating solution can be used for special electrolyzing methods, such as those known as spot or plugging or penciling galvanoplasty. In such special methods the substrate is typically not immersed into a respective electroplating solution.

WO 2018/185154 A1 discloses a method for electrolytically depositing a chromium or chromium alloy layer on a substrate.

EP 0 455 403 B1 discloses a process to regenerate a trivalent chromium bath and teaches to maintain a desired amount of ferric cations in the bath from 50 ppm to 100 ppm.

Typically, deposition methods relying on trivalent chromium are used for electrolytically depositing chromium layers on ferrous substrates, in particular on nickel or nickel alloy coated ferrous substrates, wherein often equipment parts made of iron and/or comprising copper are typically used during the deposition method for e.g. holding the substrate(s).

Typically, a trivalent chromium electroplating bath is usually used for multiple times for a deposition of a chromium layer on multiple ferrous substrates, thereby increasing the process efficiency and to allow for a significant cost reduction. However, it has been often observed that after using a trivalent chromium electroplating bath for multiple times with ferrous substrates, in particular with nickel or nickel alloy coated ferrous substrates, and iron containing equipment parts, the concentration of iron ions in such trivalent chromium electroplating baths is constantly increasing. Such increased concentrations of iron ions may result from the partial dissolution of the ferrous substrates and/or respective equipment parts in the trivalent chromium electroplating bath.

Increased concentrations of iron ions in a trivalent chromium electroplating baths in many cases leads to an undesired black discoloration of the substrates and could even significantly impair the process of depositing a chromium layer on the substrates, for example by altering the quality of the deposited chromium layers, by reducing the hardness of the deposited chromium layers, and/or by inhibiting or at least severely suppressing the chromium deposition process itself.

Moreover, after using such a trivalent chromium electroplating bath for multiple times, in some cases it is also observed that the concentration of copper and nickel ions in the trivalent chromium electroplating bath is increased, also resulting in negative effects in respect to the deposition process of chromium on the substrates, e.g. undesired discolorations.

### OBJECTIVE OF THE PRESENT INVENTION

It was therefore the objective of the present invention to provide a method for in particular reducing the concentration of contaminating iron ions in a trivalent chromium electroplating bath for electrodepositing a chromium layer, in particular a functional chromium layer. Advantageously, the concentration of disturbing iron ions is reduced along with the concentration of copper and/or nickel ions. Such a method will ensure that a respective trivalent chromium electroplating bath can be utilized over a long time, most preferably over the entire life time without compromising the quality of the functional chromium layer (e.g. in terms of hardness and wear resistance).

### SUMMARY OF THE INVENTION

The objective mentioned above is solved by a method for reducing the concentration of iron ions in a trivalent chromium electroplating bath, the method comprising the following steps:
(i) providing the trivalent chromium electroplating bath comprising
   (a) trivalent chromium ions, and
   (b) iron ions,
(ii) subjecting at least a portion of the trivalent chromium electroplating bath to air agitation, to obtain at least an air-agitated portion of the trivalent chromium electroplating bath,
(iii) contacting the air-agitated portion of the trivalent chromium electroplating bath with an ion exchange resin, to obtain a resin-treated portion of the trivalent chromium electroplating bath, and
(iv) returning the resin-treated portion of the trivalent chromium electroplating bath to the trivalent chromium electroplating bath,
   with the proviso that
   the trivalent chromium electroplating bath provided in step (i) was or is utilized for electrodepositing a chromium layer on at least one substrate applying a cathodic current density of 18 A/dm² or more,
   after step (iii), the iron ions in the resin-treated portion of the trivalent chromium electroplating bath have a lower concentration than in the air-agitated portion of the trivalent chromium electroplating bath, and
   after step (iv), the iron ions in the trivalent chromium electroplating bath have a concentration below 50 mg/L, based on the total volume of the trivalent chromium electroplating bath.

By contacting a trivalent chromium electroplating bath with an ion exchange resin (such as in step (iii) of the method of the present invention), the ion exchange resin binds cations, in particular iron ions, which have been accumulated in the trivalent chromium electroplating bath overtime, thereby reducing the concentration of iron ions in the trivalent chromium electroplating bath.

However, it has been observed that the efficiency of reducing the concentration of iron ions in the trivalent chromium electroplating bath can be significantly increased, when subjecting the trivalent chromium electroplating bath to an air agitation (such as in step (ii) of the method of the present invention) before carrying out the contacting with the ion exchange resin.

As a result, the method of the present invention combines both advantageous steps to synergistically increase the efficiency of reducing the concentration of iron ions. This combination ensures a longer life time of the trivalent chromium electroplating bath and stable quality of the electrodeposited chromium layer over time, which in turn helps to minimize waste and waste water, respectively.

By returning the resin-treated portion of the trivalent chromium electroplating bath to the trivalent chromium electroplating bath in step (iv), a continuous or at least discontinuous (semi-continuous) flow circle is preferably provided, which ensures an ongoing treatment during the method, thereby ensuring a high quality of the electrodeposited chromium layer over a long time, well comparable to a freshly set up trivalent chromium electroplating bath.

Preferred is a method of the present invention, wherein in step (i) the trivalent chromium electroplating bath further comprises (i.e. besides iron ions)
(c) copper ions, and/or
(d) nickel ions,
   with the proviso that
after step (iii), the copper ions and/or the nickel ions, respectively, in the resin-treated portion of the trivalent chromium electroplating bath have a lower concentration than in the air-agitated portion of the trivalent chromium electroplating bath, wherein preferably the copper ions and/or the nickel ions, respectively, in the resin-treated portion of the trivalent chromium electroplating have a concentration of 50 mg/L or less.

Therefore, besides reducing the concentration of iron ions in the trivalent chromium electroplating bath also the concentrations of nickel and/or copper ions can be efficiently reduced (and thereby maintained at a comparatively low concentration) by utilizing the method of the present invention.

### BRIEF DESCRIPTION OF THE TABLE

In Table 1, a schematic correlation between concentrations of iron ions with respect to the resulting optical appearance of the electrodeposited chromium layer is shown. Further details are given in the “Examples” section below in the text.

### DETAILED DESCRIPTION OF THE INVENTION

In the context of the present invention, the term “at least one” or “one or more” denotes (and is exchangeable with) “one, two, three or more” and “one, two, three or more than three”, respectively. Furthermore, “trivalent chromium” refers to chromium with the oxidation number +3. The term “trivalent chromium ions” refers to Cr³⁺-ions in a free or complexed form. Likewise, “hexavalent chromium” refers to chromium with the oxidation number +6 and thereto related compounds including ions containing hexavalent chromium.

Into the trivalent chromium electroplating bath provided in step (i) and which was or is utilized for electrodepositing the chromium layer on the at least one substrate no hexavalent chromium is intentionally added. Thus, the trivalent chromium electroplating bath provided in step (i) is substantially free of or does not comprise hexavalent chromium (except very small amounts which may be formed anodically).

The ion exchange resin utilized in step (iii) has a low selectivity for trivalent chromium ions so that the concentration of trivalent chromium ions is not significantly reduced in the resin-treated portion of the trivalent chromium electroplating bath compared to the air-agitated portion of the trivalent chromium electroplating bath. In contrast, the ion exchange resin utilized in step (iii) is substantially selective to exchange iron ions and is also preferably selective to copper and/or nickel and/or zinc ions.

The method of the present invention includes steps (i), (ii), (iii), and (iv), wherein the order preferably is (i), subsequently (ii), subsequently (iii), and subsequently (iv). In case the method refers to a closed loop cycle, after step (iv), step (i) is carried out again, followed again by step (ii), followed again by step (iii), and follow again by step (iv). Preferably, the method of the present invention comprises multiple repetitions of steps (i), (ii), (iii), and (iv).

Preferably, the trivalent chromium electroplating bath is an aqueous trivalent chromium electroplating bath comprising trivalent chromium ions and iron ions. In some cases, but less preferred, the trivalent chromium electroplating bath comprises a solvent different from water, preferably an organic solvent. Most preferably, water is the only solvent.

The present invention relies on the finding to subject at least a portion of the trivalent chromium electroplating bath to air agitation and to subsequently contact the air-agitated portion of the trivalent chromium electroplating bath with an ion exchange resin, which in turn at least partially removes iron ions from the air-agitated portion of the trivalent chromium electroplating bath, thereby reducing the concentration of iron ions in the trivalent chromium electroplating bath.

The trivalent chromium electroplating bath is preferably used more than one time for depositing a chromium layer on preferably a plurality of different substrates, preferably during a continuous process. Preferably, the trivalent chromium electroplating bath is repeatedly utilized during electroplating, preferably for a usage of at least 100 Ah per liter trivalent chromium electroplating bath, preferably at least 150 Ah per liter, more preferably at least 200 Ah per liter, most preferably at least 300 Ah per liter.

Since the trivalent chromium electroplating bath is preferably used for depositing a chromium layer on a plurality of substrates, in particular ferrous substrates, iron ions from the substrates, in particular from the ferrous substrates, can dissolute from the substrates and can accumulate in the trivalent chromium electroplating bath over time, thereby constantly increasing the concentration of iron ions in the trivalent chromium electroplating bath. By reducing the concentration of iron ions in the trivalent chromium electroplating bath through carrying out the method of the present invention, the dissolution of iron ions from the substrates during electroplating can be counterbalanced, so that a concentration of iron ions in the trivalent chromium electroplating bath below a critical limit can be maintained.

The method of the present invention allows to maintain a high-quality chromium layer comparable to a freshly set up trivalent chromium electroplating bath.

A further important finding was that the efficiency of iron ion removal by the ion exchange resin can be significantly increased if air agitation is utilized.

Preferably, the air-agitated portion of the trivalent chromium electroplating bath after air-agitation is instantly contacted with the ion exchange resin. Preferably, after air agitation the air-agitated portion of the trivalent chromium electroplating bath is transferred to the ion exchange resin without any interruption or delay. This in particular ensures that a high amount of oxygen is present in the air-agitated portion of the trivalent chromium electroplating bath before contacting the air-agitated portion of the trivalent chromium electroplating bath with the ion exchange resin, thereby increasing the efficiency of iron ion removal. Preferably, in step (ii) the trivalent chromium electroplating bath is subjected to air agitation for at least 5 min.

Another important finding according to the present invention was that reducing the concentration of iron ions in the trivalent chromium electroplating bath becomes essential when using a high-current electroplating process with cathodic current densities of 18 A/dm² or more.

While a certain concentration of iron ions in a trivalent chromium electroplating baths can be typically controlled (and even is desired in cases of decorative applications) when using low-current electroplating processes with cathodic current densities of 15 A/dm² or less, this is not the case for the above-mentioned high-current electroplating process with cathodic current densities of 18 A/dm² or more. In such high-current electroplating processes, at comparatively high iron ion concentrations in the trivalent chromium electroplating bath, iron can be incorporated into the deposited chromium layer during electroplating, thereby impairing the corrosion resistance at the corresponding locations, and also resulting in an undesired black discoloration of said deposited chromium layer.

Therefore, maintaining the iron ion concentration in the trivalent chromium electroplating bath below a limit of 50 mg/L is essential for such a high-current electroplating process, i.e. with cathodic current densities of 18 A/dm² or more.

Correspondingly to the wording used for the method of the present invention, preferred is a method of the present invention comprising, preferably prior to step (i)
electrodepositing a chromium layer on at least one substrate by applying a cathodic current density of 18 A/dm² or more and utilizing the trivalent chromium electroplating bath.

This is a preferred corresponding wording for the first proviso defined above in the context of the present invention and preferably can replace same. Preferably, during the electroplating, iron ions are accumulating in the trivalent chromium electroplating bath. Preferably after reaching an undesired amount of iron ions, said electroplating bath is subjected to steps (i) to (iv) of the method of the present invention.

Preferred is a method of the present invention, wherein in step (i) in the trivalent chromium electroplating bath the iron ions have a concentration of 40 mg/L or less, based on the total volume of the trivalent chromium electroplating bath, preferably 30 mg/L or less, more preferably 20 mg/L or less, even more preferably 15 mg/L or less, and most preferably 11 mg/L or less.

Preferred is a method of the present invention, wherein after step (iv) in the trivalent chromium electroplating bath the iron ions have a concentration of 35 mg/L or less, based on the total volume of the trivalent chromium electroplating bath, preferably 25 mg/L or less, more preferably 18 mg/L or less, even more preferably 13 mg/L or less, and most preferably 10 mg/L or less.

Preferred is a method of the present invention, wherein in step (i) in the trivalent chromium electroplating bath the iron ions have a concentration of more than 40 mg/L and after step (iv) in the trivalent chromium electroplating bath the iron ions have a concentration of 40 mg/L or less, each based on the total volume of the trivalent chromium electroplating bath, preferably in step (i) in the trivalent chromium electroplating bath the iron ions have a concentration of more than 30 mg/L and after step (iv) in the trivalent chromium electroplating bath the iron ions have a concentration of 30 mg/L or less, more preferably in step (i) in the trivalent chromium electroplating bath the iron ions have a concentration of more than 20 mg/L and after step (iv) in the trivalent chromium electroplating bath the iron ions have a concentration of 20 mg/L or less.

Preferred is a method of the present invention, wherein in step (i) in the trivalent chromium electroplating bath the iron ions have a concentration of more than 10 mg/L and after step (iv) in the trivalent chromium electroplating bath the iron ions have a concentration of 10 mg/L or less, each based on the total volume of the trivalent chromium electroplating bath.

Preferred is a method of the present invention, wherein in step (iii) in the resin-treated portion of the trivalent chromium electroplating bath the iron ions have a concentration of 9 mg/L or less, based on the total volume of the resin-treated portion of the trivalent chromium electroplating bath, preferably 8 mg/L or less, more preferably 7 mg/L or less, even more preferably 6 mg/L or less, even further more preferably 5 mg/L or less, most preferably 4 mg/L or less.

By reducing the concentration of iron ions in the trivalent chromium electroplating bath in step (iii) to a concentration, which is below 50 mg/L, in particular to a concentration of 35 mg/L or less, 25 mg/L or less, 18 mg/L or less, 13 mg/L or less, 10 mg/L or less, or even below 10 mg/L, the quality of the trivalent chromium electroplating bath is typically maintained, which allows for depositing a high-quality chromium layer on the substrate comparable to a chromium layer obtained from a freshly set up trivalent chromium electroplating bath.

In particular, a high iron ion removal efficiency of the ion exchange resin can be maintained both at high initial iron ion concentrations, i.e. when in step (i) the iron ion concentration in the trivalent chromium electroplating is more than 40 mg/L (including far more than 40 mg/L), and also at low initial iron ion concentrations, i.e. when in step (i) the iron ion concentration in the trivalent chromium electroplating is 40 mg/L or less, 30 mg/L or less, 20 mg/L or less, preferably 15 mg/L or less, or even 11 mg/L.

Preferred is a method of the present invention, wherein in step (i) the trivalent chromium electroplating bath further comprises

(c) copper ions, and/or
(d) nickel ions,
with the proviso that
after step (iii), the copper ions and/or the nickel ions, respectively, in the resin-treated portion of the trivalent chromium electroplating bath have a lower concentration than in the air-agitated portion of the trivalent chromium electroplating bath.

Due to the advantageous cation binding properties of the ion exchange resin, the ion exchange resin cannot only remove iron ions from the trivalent chromium electroplating bath in step (iii), but also copper ions and/or nickel ions.

Therefore, preferred is a method of the present invention, wherein the ion exchange resin has an affinity to iron ions and to trivalent chromium ions, wherein the affinity to iron ions is higher than the affinity to trivalent chromium ions. More preferred is a method of the present invention, wherein the ion exchange resin has an affinity to iron ions, copper ions, and nickel ions, and to trivalent chromium ions, wherein the affinity to iron ions, copper ions, and nickel ions is higher than the affinity to trivalent chromium ions.

During electroplating typically equipment parts are used, which can dissolve to a certain extent from said equipment parts so that the concentration of copper ions in the trivalent chromium electroplating bath can also increase over time, similar to the concentration of iron ions in the trivalent chromium electroplating bath.

Moreover, since the trivalent chromium electroplating is typically used to deposit a chromium layer on nickel or nickel-alloy coated substrates during electroplating, also nickel can be dissolved from said nickel or nickel-alloy coated substrates so that also the concentration of nickel ions in the trivalent chromium electroplating bath can increase over time, similar to the concentration of iron ions and/or copper ions in the trivalent chromium electroplating bath.

A comparatively high concentration of copper ions and/or nickel ions in some cases negatively affects electrodeposition of the chromium layer, when using such a trivalent chromium electroplating bath during electroplating. Therefore, it is beneficial to also reduce the concentration of copper ions and/or nickel ions in the trivalent chromium electroplating bath to allow for a deposition of a high-quality chromium layer on the substrate.

Preferred is a method of the present invention, with the proviso that
after step (iv), the copper ions in the trivalent chromium electroplating bath have a concentration of 50 mg/L or less, based on the total volume of the trivalent chromium electroplating bath, preferably 40 mg/L or less, more preferably 30 mg/L or less, even more preferably 20 mg/L or less, even further more preferably 10 mg/L or less, most preferably 5 mg/L or less.

Preferred is a method of the present invention, wherein in step (i) in the trivalent chromium electroplating bath the copper ions have a concentration of more than 10 mg/L and after step (iv) in the trivalent chromium electroplating bath the copper ions have a concentration of 10 mg/L or less.

Preferred is a method of the present invention, with the proviso that
after step (iv), the nickel ions in the trivalent chromium electroplating bath have a concentration of 50 mg/L or less, based on the total volume of the trivalent chromium electroplating bath, preferably 40 mg/L or less, more preferably 30 mg/L or less, even more preferably 20 mg/L or less, most preferably 10 mg/L or less.

Preferred is a method of the present invention, wherein in step (i) in the trivalent chromium electroplating bath the nickel ions have a concentration of more than 20 mg/L and after step (iv) in the trivalent chromium electroplating bath the nickel ions have a concentration of 20 mg/L or less.

Preferred is a method of the present invention, with the proviso that
the trivalent chromium electroplating bath provided in step (i) was or is utilized for electrodepositing a chromium layer on at least one substrate applying a cathodic current density of 20 A/dm² or more, preferably 24 A/dm² or more, more preferably 28 A/dm² or more, even more preferably 32 A/dm² or more, yet even more preferably 36 A/dm² or more, even further more preferably 39 A/dm² or more, most preferably 42 A/dm² or more.

The word “for” in the term “was or is utilized for electrodepositing a chromium layer” is preferably interpreted as “in” such that it can be read as “was or is utilized in electrodepositing a chromium layer”. In both cases it denotes that in the context of the present invention the electrodepositing takes or took place and that the defined current density is or was indeed applied to the electroplating bath. This applies in general to the method of the present invention.

Preferably, the trivalent chromium electroplating bath provided in step (i) was or is utilized for electrodepositing by applying a direct current (DC).

Preferably, the direct current (DC) is a direct current without interruptions, wherein more preferably the direct current is not pulsed (non-pulsed DC). Furthermore, the direct current preferably does not include reverse pulses.

Preferred is a method of the present invention, with the proviso that
the trivalent chromium electroplating bath provided in step (i) was or is utilized for electrodepositing a chromium layer on at least one substrate applying a cathodic current density in a range from 18 A/dm² to 75 A/dm², preferably from 24 A/dm² to 71 A/dm², more preferably from 28 A/dm² to 68 A/dm², even more preferably from 32 A/dm² to 65 A/dm², yet even more preferably from 36 A/dm² to 61 A/dm², even further more preferably from 39 A/dm² to 58 A/dm², most preferably from 42 A/dm² to 55 A/dm². Preferred are also other combinations such as e.g. 28 A/dm² to 75 A/dm² or 32 A/dm² to 71 A/dm².

Preferred is a method of the present invention, wherein the chromium layer has a thickness of 0.5 μm or more, preferably of 0.75 μm or more, more preferably of 0.9 μm or more, even more preferably of 1.0 μm or more, yet even more preferably of 1.5 μm or more, and most preferably of 2.0 μm or more.

In some cases a method of the present invention is preferred, wherein the chromium layer has a thickness in a range from 1.1 μm to 500 μm, preferably from 2 μm to 450 μm, more preferably from 4 μm to 400 μm, even more preferably from 6 μm to 350 μm, yet even more preferably from 8 μm to 300 μm, and most preferably from 10 μm to 250 μm.

In some further cases a method of the present invention is preferred, wherein the chromium layer has a thickness of 15 μm or more, preferably of 20 μm or more.

As already mentioned above, when depositing the chromium layer during electrodepositing, a chromium layer with excellent functional characteristics is preferably obtained, which is often referred to as a hard chromium layer, and preferably is not a decorative chromium layer.

Preferably, the trivalent chromium electroplating bath utilized for electrodepositing a chromium layer on at least one substrate applying a cathodic current density of 18 A/dm² or more (preferably with a cathodic current density as described above) is utilized/located in an electroplating section.

Preferred is a method of the present invention, wherein the trivalent chromium electroplating bath is located in an electroplating section, and steps (ii) and/or (iii) are performed in a treatment section, which is separated from the electroplating section but fluidically connected to the electroplating section.

Thus, preferred is that the method of the present invention is utilized in a treatment section, preferably separated from the electroplating section. Most preferably, the electroplating section is a plating tank.

Preferred is a method of the present invention, wherein the electroplating section and the treatment section are fluidically connected to each other by one or more than one conduit.

Preferred is a method of the present invention, wherein steps (i), (ii), (iii), and (iv) are performed continuously or discontinuously.

In some cases preferred is a method of the present invention, wherein steps (i), (ii), (iii), and (iv) are performed continuously, even more preferably in a closed loop. This preferably means in general, that the providing of the trivalent chromium electroplating bath in step (i) is followed by the air-agitation carried out in step (ii), which in turn is followed by the resin-treatment carried out in step (iii), which in turn is followed by returning the resin-treated portion of the trivalent chromium electroplating bath as defined in step (iv), wherein after step (iv), step (i) is carried out again, which in turn is followed by steps (ii), (iii) and (iv), respectively, and so on.

Such continuous performance of steps (i), (ii), (iii) and (iv), preferably in a closed loop, allows to very efficiently control the concentration of the iron ions, and preferably in addition of the copper and/or nickel ions.

However, in other cases is it preferred that this sequence is temporarily interrupted, most preferably after a step (iv), and performed discontinuously or semi-continuously. This in particular applies, if the iron ions have a concentration, which is slowly rising and a critical concentration is reached only after a comparatively long time. Under such circumstances the method of the present invention is preferably performed temporarily, more preferably repeatedly, until the iron ions have reached a desired concentration in the trivalent chromium electroplating bath (preferably below 10 mg/L). After that, the method of the present invention is interrupted/paused until the iron ions have reached again a critical concentration. In this way, resources and energy are better preserved.

Preferably, in step (i) of the method of the present invention at least a portion of the trivalent chromium electroplating bath is provided in a first compartment of the treatment section, preferably an overflow compartment. In this first compartment, preferably the portion of the trivalent chromium electroplating bath is subjected to air agitation, preferably for a time period as defined throughout the text, such that an air-agitated portion of the trivalent chromium electroplating bath is obtained (step (ii)). In a second compartment of the treatment section, preferably step (iii) of the method of the present invention is carried out. Preferably, the second compartment is a column filled with the ion exchange resin and the portion of the trivalent chromium electroplating bath is contacted with the ion exchange resin with a flow rate, preferably a constant flow rate. After step (iii) is carried out, the resin-treated portion of the trivalent chromium electroplating bath is obtained, which is returned as defined in step (iv) of the method of the present invention. Most preferably, the portion of the trivalent chromium electroplating bath is pumped by means of at least one pump from the first to the second compartment and back to the trivalent chromium electroplating bath. At this point, the method of the present invention is carried out continuously or discontinuously (as described above). In each case, this allows to continue running the electrodepositing of the chromium layer on the at least one substrate in the electroplating section, i.e. without interrupting the electrodepositing. In other words the method of the present invention is carried out simultaneously, i.e. while the electrodepositing is carried out too. However, in some cases it is preferred that the electrodepositing in the electroplating section is interrupted while the method of the present invention is carried out, although the method of the present invention is carried out in the treatment section.

Thus, preferred is a method of the present invention, wherein in step (iii) the ion exchange resin is provided in an ion exchange column through which the air-agitated portion of the trivalent chromium electroplating bath is passed. The ion exchange column defines a confined space for the ion exchange resin such that replacement, regeneration and/or modification is carried out independently from the electroplating section and/or the first compartment of the treatment section.

In some cases a method of the present invention is preferred, wherein the method of the present invention is carried out in the electroplating section. Under such circumstances, the electroplating of the chromium layer is preferably interrupted and temporarily stopped, respectively. The trivalent chromium electroplating bath is provided in the electroplating section (step (i)). Also subjecting to air agitation (step (ii)) is carried out in the electroplating section. Step (iii) is carried out in the electroplating section by adding the ion exchange resin for a defined period of time. Afterwards, the resin is removed (or alternatively the trivalent chromium electroplating bath is relocated into another plating tank), which means that the resin-treated trivalent chromium electroplating bath is intrinsically returned to the trivalent chromium electroplating bath. However, such a batch-approach is less preferred because removing the ion exchange resin is technically demanding and the often the resin cannot completely separated from the resin-treated trivalent chromium electroplating bath.

In some cases preferred is a method of the present invention, wherein the ion exchange resin is provided as a bed through which the air-agitated portion of the trivalent chromium electroplating bath is passed. Such a bed allows for an increased contact area between the air-agitated portion of the trivalent chromium electroplating bath and the ion exchange resin.

Preferred is a method of the present invention, wherein
the trivalent chromium electroplating bath provided in step (i) is utilized for said electrodepositing while steps (ii), (iii) and (iv) are performed, or
the trivalent chromium electroplating bath provided in step (i) was utilized for said electrodepositing prior to steps (ii), (iii) and (iv).

This preferably mans that in some cases a method of the present invention is preferred, wherein the trivalent chromium electroplating bath is used in parallel for electroplating, e.g. at the same time while the method of the present invention is carried out.

However, in some other cases it is preferred that the electroplating is already finished and a respective trivalent electroplating bath is not any longer in use until the method of the present invention is carried out. This preferably includes that the electroplating bath is even relocated in order to carry out the method of the present invention.

After the method of the present invention has been performed, preferably the electrodepositing is continued. Preferred is a method of the present invention, wherein the trivalent chromium electroplating bath obtained after step (iv) is utilized for electrodepositing a chromium layer on at least one substrate (preferably to a plurality of substrates) applying a cathodic current density of 18 A/dm² or more (preferably a cathodic current density as defined throughout the present text as being preferred) and then provided in another step (i), preferably a step (i) of a second or higher sequence of the method of the present invention.

Typically, after a certain amount of time, the ion exchange resin is saturated with ions, so that the affinity of the ion exchange resin starts decreasing. Thus, after preferably repeatedly carrying out the method of the present invention, the ion exchange resin is preferably cleaned and regenerated. This in particular means that the iron ions and preferably also the nickel and copper ions are (a) stripped off from the resin and (b) the resin is reconditioned such that the ion exchange resin is preferably utilized in a further sequence of the method of the present invention.

Preferred is a method of the present invention, further comprising step
(v) contacting the ion exchange resin after a step (iii) with an acidic and/or alkaline regeneration solution, preferably contacting the ion exchange resin periodically with an acidic regeneration solution during a regeneration interval followed by contacting it with an alkaline regeneration solution after the regeneration interval.

To strip off bound ions from the ion exchange resin in step (v), the ion exchange resin is contacted with the acidic and/or alkaline regeneration solution.

Preferably, in step (v) the ion exchange resin is more often contacted with the acidic regeneration solution than the alkaline regeneration solution, in a few cases it is preferred that the ion exchange resin is exclusively contacted with the acidic regeneration solution.

More preferably, step (v) is performed by contacting the ion exchange resin after a step (iii) with an acidic regeneration solution and with an alkaline regeneration solution. Most preferably, step (v) is performed by contacting the ion exchange resin after a step (iii) with an acidic regeneration solution for a first number of times and subsequently with an alkaline regeneration solution for a second number of times, wherein the first number of times is higher than the second number of times. Alternatively in less preferred cases, the contacting with the alkaline regeneration solution is carried out before contacting with the acidic regeneration solution.

Preferred is a method of the present invention, wherein the ion exchange resin comprises one or more than one cation exchange resin. Preferably, the one or more than one cation exchange resin is utilized in step (iii) of the method of the present invention in a hydrogen-loaded form.

Preferred is a method of the present invention, wherein the ion exchange resin comprises a polystyrene polymer. A cation exchange resin, preferably a resin comprising polystyrene polymer, typically provides a high affinity to iron ions, and preferably also to copper ions and/or nickel ions.

Preferred is a method of the present invention, wherein the ion exchange resin is macro-porous.

Preferably, the one or more than one cation exchange resin comprises two or more than two different cation exchange resins, which are differently selective for various cations, preferably for iron ions, nickel ions and copper ions.

In some cases it is preferred that the two or more than two cation exchange resins form at least a double bed.

Preferred is a method of the present invention, wherein the ion exchange resin (preferably as described above as being preferred) comprises acidic functional groups, wherein the acidic functional groups preferably comprise one or more than one group selected from carboxylic group, phosphonic group, and sulphonic group.

In some cases very preferred is an ion exchange resin comprising phosphonic groups and sulphonic groups, mostly preferred is the ion exchange resin Purolite S-957. Preferred is an ion exchange resin, wherein the phosphonic groups comprise aminophosphonic groups.

In other cases very preferred is an ion exchange resin comprising carboxylic groups, more preferably comprising acetate groups, most preferably comprising iminodiacetate groups. Mostly preferred ion exchange resins are Lewatit® TP-207 and/or Purolite® S-930.

By utilizing the above-mentioned preferred ion exchange resins, step (iii) of the method of the present invention is excellently carried out.

Preferably the electroplating section comprises at least one anode, preferably independently selected from the group consisting of graphite anodes and mixed metal oxide anodes (MMO), preferably independently selected from the group consisting of graphite anodes, and anodes of mixed metal oxide on titanium. Such anodes have shown to be sufficiently resistant in the utilized electroplating bath. Preferably, the at least one anode does not comprise any lead or chromium.

The electrodeposited chromium layer preferably is a chromium alloy layer comprising allying elements. Preferred alloying elements are carbon, nitrogen, and oxygen, preferably carbon and oxygen. Carbon is typically present in the chromium layer because of organic compounds usually present in the trivalent chromium electroplating bath. Preferably, the chromium layer does not comprise one, more than one or all elements selected from the group consisting of sulphur, nickel, copper, aluminium, tin and iron. More preferably, the only alloying elements are carbon, nitrogen, and/or oxygen, more preferably carbon and/or oxygen, most preferably carbon and oxygen. Preferably, the chromium layer contains 90 weight percent chromium or more, based on the total weight of the chromium layer, more preferably 95 weight percent or more.

Preferred is a method of the present invention, wherein in step (i) the trivalent chromium electroplating bath is essentially free of or does not comprise boric acid, preferably is essentially free of or does not comprise boron-containing compounds. Boron containing compounds are not desired because they are environmentally problematic. Containing boron containing compounds (including boric acid), waste water treatment is expensive and time consuming. Furthermore, boric acid typically shows poor solubility and therefore has the tendency to form precipitates. Although such precipitates can be solubilized upon heating, a respective trivalent chromium electroplating bath cannot be utilized for electroplating during this time. There is a significant risk that such precipitates facilitate a reduced quality of the chromium layer.

Preferred is a method of the present invention, wherein in step (i) the trivalent chromium electroplating bath is essentially free of or does not comprise organic compounds containing divalent sulfur, preferably is essentially free of or does not comprise sulfur-containing compounds with a sulfur atom having an oxidation number below +6. In some cases and undesired discoloration is observed if sulfur is incorporated into the chromium layer, in particular at a cathodic current density of 18 A/dm² or more. However, this does not exclude sulfate ions. Preferably, the trivalent chromium electroplating bath comprises in some cases sulfate ions, preferably in a total amount in a range from 50 g/L to 250 g/L, based on the total volume of the trivalent chromium electroplating bath.

Omitting organic compounds containing divalent sulfur from the trivalent chromium electroplating bath is particularly advantageous when employing the trivalent chromium electroplating bath for deposition of a hard, functional chromium layer.

The term “does not comprise” denotes that respective compounds and/or ingredients are not intentionally added to e.g. the trivalent chromium electroplating bath. This does not exclude that such compounds are dragged in as impurities of other chemicals. However, typically the total amount of such compounds and ingredients is below the detection range and therefore is not critical during the method of the present invention.

Preferred is a method of the present invention, wherein in step (i) the trivalent chromium electroplating bath furthermore comprises one or more than one compound selected from the group consisting of
one or more than one type of halogen ions, preferably bromide,
one or more than one type of alkaline metal cations, preferably sodium and/or potassium,
one or more than one organic complexing compound, preferably an aliphatic mono carboxylic organic acid and/or salts thereof,
sulfate ions, and
ammonium ions.

Preferably, in step (i) the trivalent chromium electroplating bath comprises one or more than one type of halogen ions, preferably bromide, in a concentration of at least 0.06 mol/L, based on the total volume of the trivalent chromium electroplating bath, more preferably at least 0.1 mol/L, even more preferably at least 0.15 mol/L. In particular bromide anions effectively suppress the formation of hexavalent chromium species at the at least one anode.

Preferably, in step (i) the trivalent chromium electroplating bath comprises one or more than one type of alkaline metal cations, preferably sodium and/or potassium, in a total concentration ranging from 0 mol/L to 0.5 mol/L, based on the total volume of the trivalent chromium electroplating bath, more preferably from 0 mol/L to 0.3 mol/L, even more preferably from 0 mol/L to 0.1 mol/L, and most preferably from 0 mol/L to 0.08 mol/L. Typically, rubidium, francium, and caesium ions are not utilized in a trivalent chromium electroplating bath. Thus, in most cases the total amount of alkali metal cations includes metal cations of lithium, sodium and potassium, most preferably sodium and/or potassium.

The trivalent chromium electroplating bath furthermore preferably comprises one or more than one organic complexing compound, preferably for complexing the trivalent chromium ions. Preferably, the one or more than one organic complexing compound (and its preferred variants) has 1 to 10 carbon atoms, preferably 1 to 5 carbon atoms, even more preferably 1 to 3 carbon atoms. The complexing compound primarily form complexes with the trivalent chromium ions in the trivalent chromium electroplating bath to increase bath stability. Preferably, the trivalent chromium ions and the one or more than one organic complexing compound form a molar ratio in a range from 1:0.5 to 1:10.

The ammonium ions are preferably provided only by means of NH₄OH and/or NH₃.

Preferred is a method of the present invention, wherein the trivalent chromium electroplating bath utilized for electrodepositing the chromium layer on the at least one substrate (and preferably also a provided in step (i) of the method of the present invention) has a pH in a range from 4.1 to 7.0, preferably from 4.6 to 6.8, more preferably from 5.1 to 6.5, even more preferably from 5.2 to 6.2, yet even more preferably from 5.3 to 6.0, most preferably from 5.4 to 5.9.

Preferred is a method of the present invention, wherein in step (i) the trivalent chromium electroplating bath comprises trivalent chromium ions in a concentration ranging from 10 g/L to 30 g/L, based on the total volume of the trivalent chromium electroplating bath, preferably from 14 g/L to 27 g/L, more preferably from 17 g/L to 24 g/L.

Preferred is a method of the present invention, wherein in step (i) the trivalent chromium ions in the trivalent chromium electroplating bath are obtained from a soluble, trivalent chromium ion containing source, typically a water-soluble salt comprising said trivalent chromium ions. Preferably, the soluble, trivalent chromium ion containing source comprises or is chromium sulfate, more preferably acidic chromium sulfate, even more preferably chromium sulfate with the general formula Cr₂(SO₄)₃ and a molecular weight of 392 g/mol. In other cases a soluble, trivalent chromium ion containing source is preferred, wherein the source comprises an organic anion as counter ion for the trivalent chromium ions, preferably an organic carboxylic acid anion, most preferably an aliphatic, monocarboxylic acid anion with preferably 10 or less carbon atoms (preferably 5 or less carbon atoms).

If the total amount of trivalent chromium ions is significantly below 10 g/L in many cases an insufficient deposition of the chromium layer is observed, and the deposited chromium layer is usually of low quality. If the total amount is significantly above 30 g/L, the electroplating bath is in many cases no longer stable, which includes formation of undesired precipitates.

Preferred is a method of the present invention, wherein the trivalent chromium electroplating bath utilized for electrodepositing the chromium layer on the at least one substrate has a temperature in a range from 20° C. to 90° C., preferably from 30° C. to 70° C., more preferably from 40° C. to 60° C., and most preferably from 45° C. to 60° C. In the preferred temperature range an optimal electrodepositing can be obtained. If the temperature significantly exceeds 90° C., an undesired vaporization occurs, which can negatively affect the concentration of the bath components. Furthermore, the undesired anodic formation of hexavalent chromium is significantly less suppressed. If the temperature is significantly below 20° C. the deposition is in many cases insufficient.

Preferred is a method of the present invention, wherein the at least one substrate comprises a metal or metal alloy, preferably comprises one or more than one metal selected from the group consisting of copper, iron, nickel and aluminum, more preferably comprises one or more than one metal selected from the group consisting of copper, iron, and nickel, most preferably comprises at least iron.

Preferred is a method of the present invention, wherein the at least one substrate comprises iron, preferably iron exposed on at least one surface of said substrate. However, especially a substrate comprising iron exposed on at least one surface, shows a tendency that iron ions are dissolved in the trivalent chromium electroplating bath and start to accumulate over time.

Preferred is a method of the present invention, wherein in step (i) the source of the iron ions is the at least one substrate and/or means for positioning the at least one substrate in the electroplating section.

Preferred is a method of the present invention, wherein the chromium layer is electrodeposited on a surface of said at least one substrate, the surface comprising nickel or a nickel alloy (a nickel or nickel alloy coated substrate, preferably a nickel or nickel alloy coated ferrous substrate). However, under such circumstances, such a substrate shows a certain tendency that nickel ions are dissolved in the trivalent chromium electroplating bath and start to accumulate over time.

The coated substrate is preferably substrate coated with a semi-bright nickel coating. In particular preferred is a steel substrate coated with a nickel or nickel alloy layer, preferably with a semi-bright coating. However, preferably other coatings are alternatively or additionally present. In many cases such a coating significantly increases corrosion resistance compared to a metal substrate without such a coating. However, in some cases the at least one substrate is not susceptible to corrosion due to a corrosion inert environment (e.g. in an oil bath). In such a case a coating, preferably a nickel or nickel alloy layer, is not necessarily needed.

Preferred is a method of the present invention, wherein step (ii) is carried out for a minimum for 5 minutes or more, more preferably for 10 minutes or more, even more preferably for 15 minutes or more, and most preferably for 20 minutes or more. Own experiments have shown that a time period of (significantly) below 5 minutes in many cases does not significantly improve the efficiency of step (iii) of the method of the present invention. However, with a time period of at least 5 minutes in step (ii), a sufficient efficiency is obtained in step (iii).

Preferred is a method of the present invention, wherein step (ii) is carried out for a maximum for 120 minutes or less, preferably for 100 minutes or less, more preferably for 70 minutes or less, even more preferably for 50 minutes or less, and most preferably for 40 minutes or less. Own experiments have shown that upon further increasing the time period in step (iii) no additional efficiency can be gained.

Air-agitation as defined in step (ii) of the method of the present invention is preferably a strong blowing in of preferably ambient air, i.e. a strong air agitation. It is preferably stronger than conventionally used mild air agitation in order to achieve a steady bath movement during electroplating.

The present invention is described in more detail by the following non-limiting examples.

### EXAMPLES

### 1. Preparing the Trivalent Chromium Electroplating Bath:

A test trivalent chromium electroplating bath (A) (volume 1 L) and (B) (volume 500 L) was prepared, each containing 10 g/L to 30 g/L trivalent chromium ions (source: basic chromium sulfate), 50 g/L to 250 g/L sulfate ions, at least one organic complexing compound (an aliphatic mono carboxylic organic acid), ammonium ions, and bromide ions. The electroplating baths did not contain boric acid nor any boron containing compounds and no organic compounds with divalent sulfur. The pH was in a range from 5.4 to 5.9.

The initial concentration of iron ions prior to steps (ii) and (iii) of the method of the present invention was as follows in the respective test baths:

(A) 100 mg/L,
(B) 20 mg/L,

Prior to steps (ii) and (iii) each test trivalent chromium electroplating bath was utilized for electrodepositing a chromium layer on 10 mm to 30 mm diameter mild steel rod substrates applying a cathodic current density of 40 A/dm² at 50° C., wherein for test bath (A) electrodeposition was carried out for 15 minutes, and for test bath (B) for at least 120 minutes. In each case, the electrodeposited chromium layer has a thickness of at least 1 μm, in many cases of at least 5 μm. After electrodeposition, the substrates were visually inspected and rated.

After electrodeposition, test bath (A) was subjected to strong air agitation (with ambient air) in step (ii) for the following time lengths: 1 minute (A-1), 5 minutes (A-5), 15 minutes (A-15), 30 minutes (A-30), 60 minutes (A-60), 180 minutes (A-180) resulting in the respective individual air-agitated test trivalent chromium electroplating baths (A-1), (A-5), etc.

In a comparative test bath (Ac0) no air agitation was applied after step (i), but it was immediately (i.e. after 0 hours) proceeded with step (iii). In further comparative test baths, each bath after step (i) was allowed under stirring to rest for a specific time (3 hours, 6 hours, and 12 hours) followed by step (iii). Thus, in each comparative test bath step (ii) was not carried out. Thus, the following corresponding further comparative test baths were obtained: (Ac3), (Ac6), and (Ac12).

Test bath (B) was subjected to strong air agitation in step (ii) with ambient air for 15 minutes to obtain a respective air agitated test bath (B-15). In a comparative test bath no air agitation was applied and step (iii) was carried out immediately (i.e. after resting of 0 hours) after step (i); comparative test bath (Bc0) was obtained.

In step (iii) of the method of the present invention, test baths (A-1), (A-5), (A-15), (A-30), (A-60), (A-180), (Ac0), (Ac3), (Ac6), (Ac12), (Bc0) and (B-15) were contacted with an ion exchange resin (Lewatit® TP 207, Lanxess; macroporous, iminodiacetic acid functional groups, bead size: 0.4 to 1.25 mm) to obtain respective resin-treated test baths.

Test baths (A), i.e. (A-1), (A-5) etc. were contacted with the resin by adding 40 ml of the resin to each of the test baths and slightly stirred for 60 minutes. Afterwards, the resin was allowed to settle, and the supernatant was decanted and analyzed with respect to the iron ion concentration.

Test baths (B), i.e. (B-15) and (Bc0) were contacted with the resin by pumping the test bath over a column containing 25 L of the resin with a flow rate of approximately 175 L/h for 9 hours and returned to the test bath. Afterwards, the iron ion concentration was determined.

The results are summarized in Table 1.

TABLE 1

| | Fe ions [mg/L] | Optical appearance [rating] |
|---|---|---|
| (A) | 100 | + |
| (A-1) | 57 | + |
| (A-5) | 43 | ++ |
| (A-15) | <10 | +++ |
| (A-30) | <10 | +++ |
| (A-60) | <10 | +++ |
| (A-180) | <10 | +++ |
| (Ac0) | 59 | + |
| (Ac3) | 69 | + |
| (Ac6) | 62 | + |
| (Ac12) | 51 | + |
| (B) | 20 | ++ |
| (Bc0) | 14 | ++ |
| (B-15) | 4 | +++ |

The rating was as follows:
+ means: bad, i.e. partially strong and very undesired black discoloration, skip plating, very low deposition rate up to even no plating
++ means: acceptable in few cases, i.e. often black discoloration; in many cases skip plating, low deposition rate
+++ means: good, i.e. no skip plating, desired deposition rate, no disturbing discolorations; comparable to results obtained from an iron ion-free bath

The experimental results clearly show that by means of the method of the present invention the concentration of iron ions can be significantly reduced, in particular below 10 mg/L. Example (Ac0) indicates that step (ii) is essentially increasing the efficiency of reducing the concentration of iron ions in order to obtain acceptable electrodepositing results. Examples (A-1), basically a comparative example, and (A-5) indicate that 50 mg/L is a critical limit. Thus, step (ii) is applied for a sufficient time such that the critical limit is at least undercut. Above 50 mg/L typically totally inacceptable electrodepositing results are obtained. Slightly below 50 mg/L (example (A-5)) the electrodepositing result is improved; however, undesired discolorations are frequently observed. Examples (A-15) to (A-180) clearly show that excellent electrodepositing results are obtained if the iron ion concentration is below 10 mg/L. It appears that 10 mg/L is the acceptable limit if iron ion contamination is present in a respective trivalent chromium electroplating bath. This is confirmed in test bath (B), in particular (B-15). Although electrodeposits from (Bc0) are slightly better than (B), in a few cases slight discolorations are observed in (Bc0). Such discolorations were no longer observed in (B-15).

In additional test experiments (data not shown) the removal of nickel and copper ions was studied. The concentration of nickel ions as well as of copper ions was significantly reduced in these additional test experiments (Cu: from 20 mg/L to below 10 mg/L; Ni: from 43 mg/L to below 20 mg/L, even below 10 mg/L).

In further test experiments alternative resins were tested, such as (i) S-950, Purolite®; macroporous, aminophosphonic functional groups, bead size: appr. 1.2 mm; (ii) S-957, Purolite®, macroporous, phosphonic and sulphonic acid functional groups, bead size: 0.55 to 0.75 mm); and (iii) S-930, Purolite®; macroporous, iminodiacetic functional groups, bead size: appr. 0.6 nm to 0.85 mm. Similar results regarding removing iron ions, as well as removing nickel and copper ions were obtained with the alternative resins (data not shown).

### 2. Ion Exchange Resin Cleaning/Regeneration:

After example (B-0), it was necessary to clean and regenerate the ion exchange resin by repeatedly contacting the resin with a sequence of an acidic (HCl) and alkaline (NaOH) solution. This was an intensive cleaning/regeneration, which is typically not immediately required if step (ii) of the method of the present invention is carried for a first time. For example, after example (B-15) the ion exchange resin was utilized again for at least a second step (ii) before cleaning with an acidic solution (HCl). Afterwards the cleaned resin was utilized again. This was repeated for several times before a sequence of an alkaline solution (NaOH) followed by an acidic solution (HCl) was required. Thus, the method of the present invention (i.e. step (ii)) positively affects the cleaning/regeneration of the ion exchange resin.

1. A method for reducing the concentration of iron ions in a trivalent chromium electroplating bath, the method comprising the following steps:
(i) providing the trivalent chromium electroplating bath comprising
(a) trivalent chromium ions, and
(b) iron ions,
(ii) subjecting at least a portion of the trivalent chromium electroplating bath to air agitation, to obtain at least an air-agitated portion of the trivalent chromium electroplating bath,
(iii) contacting the air-agitated portion of the trivalent chromium electroplating bath with an ion exchange resin, to obtain a resin-treated portion of the trivalent chromium electroplating bath, and
(iv) returning the resin-treated portion of the trivalent chromium electroplating bath to the trivalent chromium electroplating bath,
with the proviso that
the trivalent chromium electroplating bath provided in step (i) was or is utilized for electrodepositing a chromium layer on at least one substrate applying a cathodic current density of 18 A/dm² or more,
after step (iii), the iron ions in the resin-treated portion of the trivalent chromium electroplating bath have a lower concentration than in the air-agitated portion of the trivalent chromium electroplating bath, and
after step (iv), the iron ions in the trivalent chromium electroplating bath have a concentration below 50 mg/L, based on the total volume of the trivalent chromium electroplating bath.

2. The method according to claim 1, wherein in step (i) in the trivalent chromium electroplating bath the iron ions have a concentration of 40 mg/L or less, based on the total volume of the trivalent chromium electroplating bath.

3. The method according to claim 1, wherein after step (iv) in the trivalent chromium electroplating bath the iron ions have a concentration of 35 mg/L or less, based on the total volume of the trivalent chromium electroplating bath.

4. The method according to claim 1, wherein in step (i) in the trivalent chromium electroplating bath the iron ions have a concentration of more than 10 mg/L and after step (iv) in the trivalent chromium electroplating bath the iron ions have a concentration of 10 mg/L or less, each based on the total volume of the trivalent chromium electroplating bath.

5. The method according to claim 1, wherein in step (iii) in the resin-treated portion of the trivalent chromium electroplating bath the iron ions have a concentration of 9 mg/L or less, based on the total volume of the resin-treated portion of the trivalent chromium electroplating bath.

6. The method according to claim 1, wherein in step (i) the trivalent chromium electroplating bath further comprises
(c) copper ions, and/or
(d) nickel ions,
with the proviso that
after step (iii), the copper ions and/or the nickel ions, respectively, in the resin-treated portion of the trivalent chromium electroplating bath have a lower concentration than in the air-agitated portion of the trivalent chromium electroplating bath.

7. The method according to claim 1, with the proviso that
the trivalent chromium electroplating bath provided in step (i) was or is utilized for electrodepositing a chromium layer on at least one substrate applying a cathodic current density of 20 A/dm² or more.

8. The method according to claim 1, wherein the chromium layer has a thickness of 0.5 μm or more.

9. The method according to claim 1, wherein steps (i), (ii), (iii), and (iv) are performed continuously or discontinuously.

10. The method according to claim 1, wherein
the trivalent chromium electroplating bath provided in step (i) is utilized for said electrodepositing while steps (ii), (iii) and (iv) are performed,
or
the trivalent chromium electroplating bath provided in step (i) was utilized for said electrodepositing prior to steps (ii), (iii) and (iv).

11. The method according to claim 1, wherein the trivalent chromium electroplating bath is located in an electroplating section, and steps (ii) and/or (iii) are performed in a treatment section, which is separated from the electroplating section but fluidically connected to the electroplating section.

12. The method according to claim 1 further comprising step
(v) contacting the ion exchange resin after a step (iii) with an acidic and/or alkaline regeneration solution.

13. The method according to claim 1, wherein the ion exchange resin comprises acidic functional groups.

14. The method according to claim 1, wherein in step (i) the trivalent chromium electroplating bath furthermore comprises one or more than one compound selected from the group consisting of
one or more than one type of halogen ions,
one or more than one type of alkaline metal cations,
one or more than one organic complexing compound,
sulfate ions, and
ammonium ions.

15. The method according to claim 1, wherein the trivalent chromium electroplating bath utilized for electrodepositing the chromium layer on the at least one substrate has a pH in a range from 4.1 to 7.0.

16. The method according to claim 1, wherein the chromium layer is a hard chromium layer and not a decorative chromium layer.
